(19) United States
(12) Patent Application Publication
(10) Pub. No.: US 2011/0294493 A1
(43) Pub. Date: Dec. 1, 2011

(54) MODULATING CELL INFORMATION ON A PHYSICAL CHANNEL

(75) Inventors: Sumeeth Nagaraja, San Diego, CA (US); Vinay Chande, San Diego, CA (US); Mehmet Yavuz, San Diego, CA (US); Farhad Meshkati, San Diego, CA (US)

(73) Assignee: QUALCOMM INCORPORATED, San Diego, CA (US)

(21) Appl. No.: 12/952,921

(22) Filed: Nov. 23, 2010

Related U.S. Application Data
(60) Provisional application No. 61/264,581, filed on Nov. 25, 2009.

(51) Int. Cl. H04W 4/00

(52) U.S. Cl. 455/422.1

(57) ABSTRACT

An access point transmits cell information via a physical layer channel. In some cases, the cell information sent on the physical layer channel comprises a physical layer identifier. For example, a physical layer channel may be modulated based on a cell identifier and/or a closed subscriber group identifier associated with the access point. Through the use of this cell information, an access point may be quickly identified for mobility and/or interference management operations. In addition, this cell information may be used for finger-printing operations.

### CLAIM OF PRIORITY

This application claims the benefit of and priority to commonly owned U.S. Provisional Patent Application No. 61/264,581, filed Nov. 25, 2009, and assigned Attorney Docket No. 100450P1, the disclosure of which is hereby incorporated by reference herein.

### CROSS-REFERENCE TO RELATED APPLICATION

This application is related to concurrently filed and commonly owned U.S. Pat. No. ______, entitled “LOCATION-BASED SERVICE BASED ON ACCESS POINT IDENTIFIERS,” and assigned Attorney Docket No. 100450U2, the disclosure of which is hereby incorporated by reference herein.

### BACKGROUND

1. Field

This application relates generally to wireless communication and more specifically, but not exclusively, to providing cell information via a physical channel.

2. Introduction

A wireless communication network may be deployed over a defined geographical area to provide various types of services (e.g., voice, data, multimedia services, etc.) to users within that geographical area. In a typical cellular network implementation, macro access points (e.g., each of which provides service via one or more cells) are distributed throughout the network to provide wireless connectivity for access terminals (e.g., cell phones) that are operating within the geographical area served by the macro network. A macro network deployment is carefully planned, designed and implemented to offer good coverage over the geographical region. Such careful planning cannot, however, completely accommodate channel characteristics such as path loss, fading, multipath, shadowing, and so on, in indoor environments. Indoor users, therefore, often face coverage issues (e.g., call outages, quality degradation) resulting in poor user experiences.

To supplement conventional network access points (e.g., to provide extended network coverage), small-coverage access points (e.g., low power access points) may be deployed to provide more robust indoor wireless coverage or other coverage to access terminals inside homes, enterprise locations (e.g., offices), or other locations. Such small-coverage access points may be referred to as, for example, femto cells, femto access points, Home Node Bs, Home eNode Bs, or access point base stations. Typically, such small-coverage access points are connected to the Internet and the mobile operator's network via a DSL router or a cable modem. For convenience, small-coverage access points may be referred to as femto cells or femto access points in the discussion that follows.

An unplanned deployment of large numbers of femto cells may present various operational issues. As one example, a scrambling code such as a pseudorandom noise (PN) sequence is typically used to uniquely identify cells in a cellular network. However, the number of femto cells in a network is typically much larger than the number of scrambling codes allotted for the femto cells. As a result, scrambling codes are reused, which results in ambiguities during the femto cell identification process (e.g., during handover to or from a femto cell).

To overcome this problem, in a UMTS or UTRA network, access terminals (e.g., Rel 9 or higher UEs) may read cell information such as a cell identifier (cell ID) and a closed subscriber group identifier (CSG ID) from system information broadcast (SIB) messages transmitted by cells in the network. Consequently, an idle mode or active mode access terminal is able to obtain cell information of all potential target access points by decoding received SIB messages (e.g., Layer 3 messages comprising overhead messages in the form of packets). These SIB messages have a certain repetition rate and are scheduled at certain intervals. Consequently, the access terminal may need to wait for an extended period of time to decode SIB messages from a target access point to obtain an identifier of the target access point. For example, it may take on the order of one second to determine a cell identifier from an intra-frequency cell, and even longer to determine a cell identifier from an inter-frequency cell (e.g., due to re-tuning and resynchronization times).

This extended wait period may impact network performance. For example, in active mode issues may arise such as delayed hard handovers, frame errors, frequent invocation of compressed mode (e.g., which may impact macro cell capacity), and so on. As another example, in idle mode an access terminal may need to be awake for a longer duration to read cell specific information (e.g., from the SIB). This may, in turn, adversely impact standby time. Consequently, a need exists for effective and techniques for obtaining information (e.g. identifiers) relating to access points in wireless networks.

### SUMMARY

A summary of several sample aspects of the disclosure follows. This summary is provided for the convenience of the reader and does not wholly define the breadth of the disclosure. For convenience, the term some aspects may be used herein to refer to a single aspect or multiple aspects of the disclosure.

The disclosure relates in some aspects to providing cell information on a radiofrequency (RF) physical channel. For example, an access point may modulate an RF physical layer channel based on an identifier associated with the access point. In this way, access terminals or other entities may quickly decode the cell information (without waiting for cell broadcast messages), and use the cell information take any desired steps towards mobility, interference, and location-based (e.g., finger-printing) operations relating to that access point.

In some implementations, an access points transmits cell information via a synchronization channel. For example, in a UMTS/UTRA network, an access point (e.g., a Home Node B) may transmit cell information over one or both of the synchronization channels (primary synchronization channel and/or secondary synchronization channel). Here, the cell information (e.g., a codeword based on the cell information) is modulated by the primary synchronization code and/or secondary synchronization code depending on the channel. An access terminal (e.g., a UE) in the vicinity of the access points may acquire this cell information as it performs initial acquisition of target cells. This may involve a three step synchronization procedure of: acquiring slot timing, acquiring frame timing, and identifying the primary scrambling code (PSC) used by the access point. Once the access point obtains the slot and frame boundaries, the access point may decode the cell information sent on the synchronization channel.

The disclosure relates in some aspects to an access point that transmits cell information on an RF physical channel. For example, the access point may identify cell information associated with the access point, and transmit the cell information by modulating an RF physical channel based on the cell information.

The disclosure relates in some aspects to an entity such as an access terminal that obtains cell information via an RF physical channel and uses the cell information for mobility, interference, finger-printing, or other operations. For example, such an entity may receive radiofrequency physical channel signals that are modulated based on cell information associated with an access point, and derive the cell information by demodulating the radiofrequency physical channel signals.

The disclosure relates in some aspects to location-based operations that are based on identifiers received from access points. These operations may involve, for example, receiving signals from a plurality of access points, determining identifiers associated with the access points based on the received signals, and performing a location-based service based on the determination of the identifiers.

### BRIEF DESCRIPTION OF THE DRAWINGS

These and other sample aspects of the disclosure will be described in the detailed description and the appended claims that follow, and in the accompanying drawings, wherein:

FIG. 1 is a simplified block diagram of several sample aspects of a communication system wherein cell information is provided via a physical channel;

FIG. 2 is a flowchart of several sample aspects of operations that may be performed in conjunction with providing cell information via a physical channel;

FIG. 3 is a simplified diagram illustrating sample slot and frame timing on synchronization channels;

FIG. 4 is a flowchart of several sample aspects of operations that may be performed in conjunction with transmitting cell information on a physical channel;

FIG. 5 is a flowchart of several sample aspects of operations that may be performed in conjunction with receiving cell information on a physical channel;

FIG. 6 is a flowchart of several sample aspects of operations that may be performed in conjunction with performing a location-based service based on access point identifiers obtained from received signals;

FIG. 7 is a simplified block diagram of several sample aspects of components that may be employed in communication nodes;

FIG. 8 is a simplified diagram of a wireless communication system;

FIG. 9 is a simplified diagram of a wireless communication system including femto nodes;

FIG. 10 is a simplified diagram illustrating coverage areas for wireless communication;

FIG. 11 is a simplified block diagram of several sample aspects of communication components; and

FIGS. 12-14 are simplified block diagrams of several sample aspects of apparatuses operable to provide functionality as taught herein.

In accordance with common practice the various features illustrated in the drawings may not be drawn to scale. Accordingly, the dimensions of the various features may be arbitrarily expanded or reduced for clarity. In addition, some of the drawings may be simplified for clarity. Thus, the drawings may not depict all of the components of a given apparatus (e.g., device) or method. Finally, like reference numerals may be used to denote like features throughout the specification and figures.

### DETAILED DESCRIPTION

Various aspects of the disclosure are described below. It should be apparent that the teachings herein may be embodied in a wide variety of forms and that any specific structure, function, or both being disclosed herein is merely representative. Based on the teachings herein one skilled in the art should appreciate that an aspect disclosed herein may be implemented independently of any other aspects and that two or more of these aspects may be combined in various ways. For example, an apparatus may be implemented or a method may be practiced using any number of the aspects set forth herein. In addition, such an apparatus may be implemented or such a method may be practiced using other structure, functionality, or structure and functionality in addition to or other than one or more of the aspects set forth herein. Furthermore, an aspect may comprise at least one element of a claim.

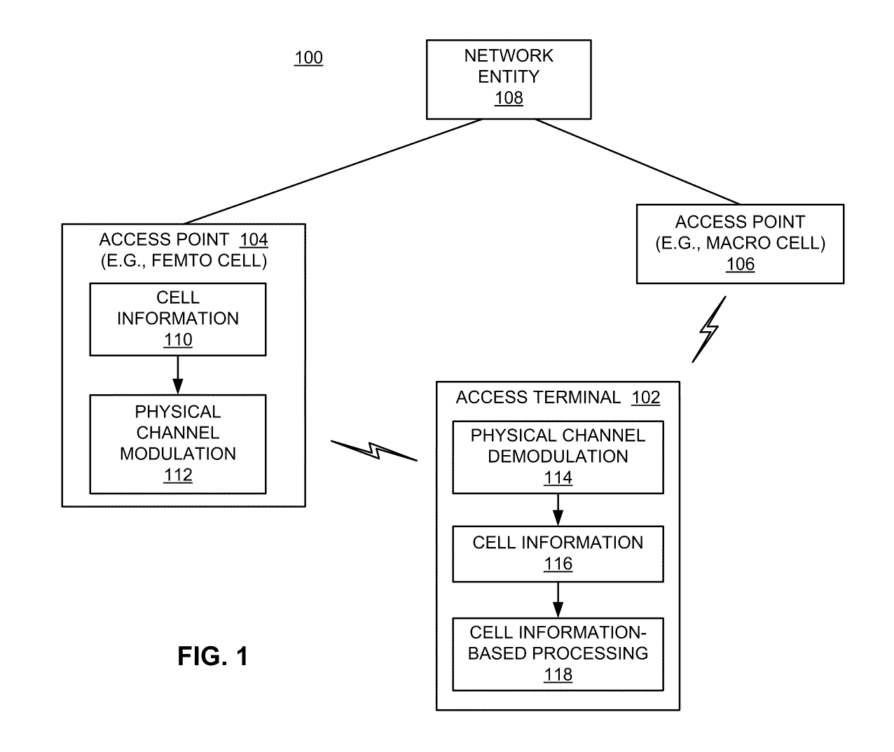

FIG. 1 illustrates several nodes of a sample communication system 100 (e.g., a portion of a communication network). For illustration purposes, various aspects of the disclosure will be described in the context of one or more access terminals, access points, and network entities that communicate with one another. It should be appreciated, however, that the teachings herein may be applicable to other types of apparatuses or other similar apparatuses that are referenced using other terminology. For example, in various implementations access points may be referred to or implemented as base stations, Node Bs, eNode Bs, femto cells, Home Node Bs, Home eNode Bs, and so on, while access terminals may be referred to or implemented as user equipment (UEs), mobile stations, and so on.

Access points in the system 100 provide access to one or more services (e.g., network connectivity) for one or more wireless terminals (e.g., the access terminal 102) that may be installed within or that may roam throughout a coverage area of the system 100. For example, at various points in time the access terminal 102 may connect to an access point 104, an access point 106, or some other access point in the system 100 (not shown). Each of these access points may communicate with one or more network entities (represented, for convenience, by the network entity 108) to facilitate wide area network connectivity.

These network entities may take various forms such as, for example, one or more radio and/or core network entities. Thus, in various implementations the network entities may represent functionality such as at least one of: network management (e.g., via an operation, administration, management, and provisioning entity), call control, session management, mobility management, gateway functions, interworking functions, or some other suitable network functionality. Also, two of more of these network entities may be co-located and/or two or more of these network entities may be distributed throughout a network.

The access point 104 (e.g., a femto cell) uses physical channel modulation 112 to transmit cell information 110 to neighboring nodes. For example, the access point may encode a cell ID or a CSG ID and modulate the resulting encoded signal using a code associated with an RF physical layer channel. This physical channel does not carry higher layer information (e.g., Layer 3 packets). In some implementations, the physical channel is a synchronization channel. In this case, the encoded information may be modulated by a synchronization code for that channel. In any event, the access point transmits the resulting modulated signal to provide the physical channel (e.g., on an allocated downlink RF carrier frequency).

When the access terminal 102 is in the vicinity of the access point 104, the access terminal 102 may derive the cell information embedded in this physical channel. Here, the access terminal 102 employs appropriate physical channel demodulation 114 on the signals received on the physical channel to derive cell information 116. As a result, the access terminal 102 will be able to perform cell information-based processing 118 based on the derived cell information 116.

The access terminal 102 may uniquely identify the access point 104 based on the cell information 116 and use this information for various operations. For example, as described in more detail below, such a scheme may be used in conjunction with idle mode and active mode mobility management procedures. In addition, this scheme may be used in conjunction with access point (e.g., femto cell) identification and interference management procedures. Also, this scheme may be used in conjunction with providing location-based services.

Also as described below, an encoding method for the transmission of cell information over a physical channel as taught herein may employ certain properties that help ensure backward compatibility and that provide robustness against potential problems that may be encountered with transmission over a physical channel. In some aspects, the encoding method may ensure compatibility with legacy access terminals. In some aspects, the encoding method may provide robustness against channel errors. In some aspects, the encoding method may provide robustness in detecting boundaries of the cell information. These properties may be achieved, for example, through the use of at least one of: linear-code properties, non-cyclic codes, or code-start delimiters.

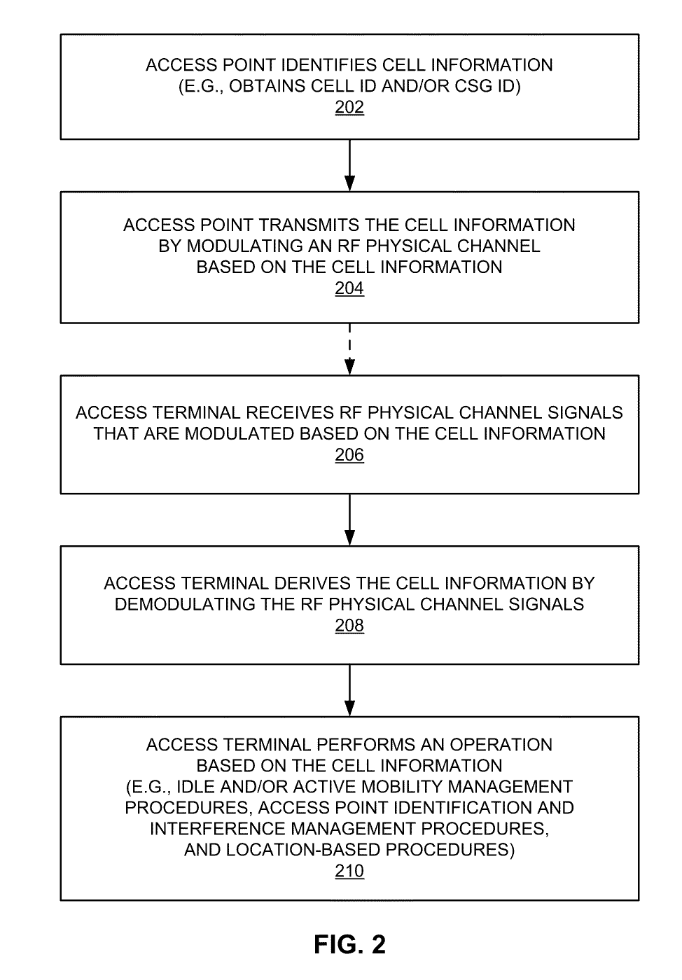

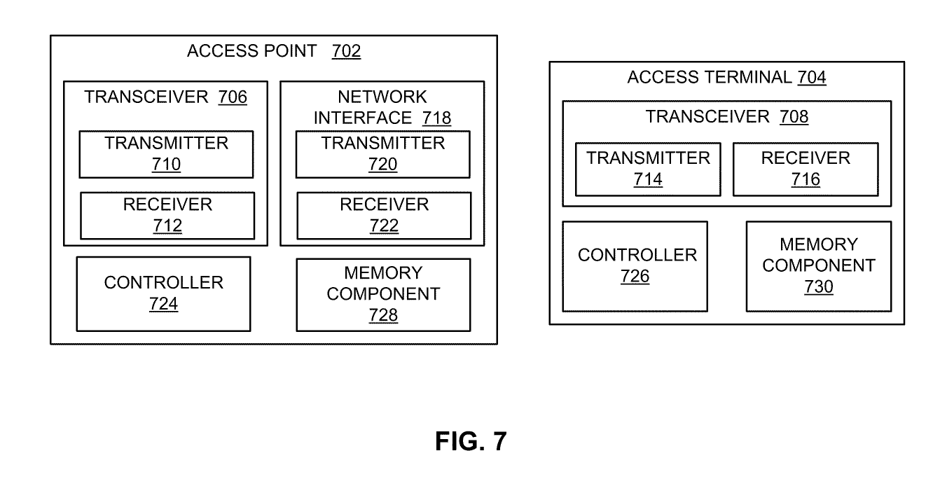

Sample operations relating to providing cell information via a physical channel will now be described in more detail in conjunction with FIGS. 2-6. For convenience, the operations of FIGS. 2-6 (or any other operations discussed or taught herein) may be described as being performed by specific components (e.g., components of FIG. 1 and FIG. 7). It should be appreciated, however, that these operations may be performed by other types of components and may be performed using a different number of components. It also should be appreciated that one or more of the operations described herein may not be employed in a given implementation.

FIG. 2 describes sample operations performed by an access point (e.g., a femto cell) and an access terminal (e.g., a UE) to enable the access terminal to acquire cell information from the access point via physical channel signaling.

As represented by block 202, the access point identifies the cell information to be transmitted over the physical channel. For example, the access point may obtain the cell information from a memory component of the access point as a result of this information being configured into the access point by a network entity or some other entity, or as a result of the access point deriving this information in some manner.

The cell information may take various forms. For example, in some implementations the cell information may be a cell ID, a CSG ID, or some other identifier associated with the access point (e.g., associated with a cell of the access point). Such an identifier may be referred to as a physical layer identifier. Other types of cell information (e.g., other than identifiers) may be used in other implementations.

As represented by block 204, the access point transmits the cell information by modulating an RF physical channel based on the cell information. In some aspects, the modulation of the physical channel in this manner involves initially encoding the cell information to, for example, improve system performance with respect to various factors.

In some aspects, the encoding method used for the cell information may provide robustness against channel errors. For example, error correcting coding (e.g., error correction encoding) may be applied to the cell information, whereby the physical channel is modulated based on the resulting codeword. In this way, redundancy bits are added to the cell information (to provide the codeword) to enable an access terminal that receives this information to correct any errors in the information.

The encoding method used for the cell information also may provide robustness in detecting a boundary of the cell information. For example, in some cases the length of the cell information (e.g., before or after error correction encoding) results in the cell information needing to be transmitted over more than one frame. In other words, the transmitted cell information spans multiple frames. However, since the cell information is sent repeatedly, an access terminal that receives this cell information may not know which received frame contains the beginning of the cell information. In such cases, the encoding method may encode the cell information in such a way as to enable an access terminal that receives this cell information to identify the boundaries (e.g., the beginning and end) of the cell information.

In some implementations, frame boundary disambiguation is achieved by including a start-of-frame delimiter and/or an end-of-frame delimiter with the cell information. In this case, an access terminal that receives the cell information is able to identify the beginning and/or the end of the cell information based on the delimiter(s).

In some implementations, frame boundary disambiguation is facilitated by providing a codeword with an acyclic property. For example, the cell information (e.g., the codeword) is transmitted periodically. Thus, the information being modulated is a periodic sequence. Moreover, a type of encoding (e.g., tail-biting convolutional encoding) may be used to enable the data to be decoded without knowing the beginning of the cell information (e.g., the codeword). Consequently, the access terminal only needs to decode and acquire the specified number of bits to recover all of the data for the cell information. The access terminal does not need to know the correct sequence for that data to decode the data. Other techniques may then be employed as discussed herein for determining the correct sequence.

In some implementations, frame boundary disambiguation is achieved through the use of certain cyclic redundancy check (CRC) properties. For example, the CRC algorithm may be chosen so that different CRC checksums will result if the received frames are processed in different orders. For example, if the cell information spans three frames (1, 2, 3), the cell information may be received in the order frames 1, 2, 3, or frames 2, 3, 1, or frames 3, 2, 1. Accordingly, if the CRC checksum sent with the cell information only corresponds to the 1, 2, 3, order, the access terminal that receives the cell information will be able to determine the beginning frame boundary by performing a CRC operation on the received cell information and comparing the resulting CRC checksum with the CRC checksum sent with the cell information.

In some cases (e.g., where signaling for an existing physical channel is modified to accommodate cell information), the encoding method used for the cell information is selected to ensure backward compatibility. Here, the encoding may be selected so that the inclusion of cell information on the physical channel has minimal or no impact on the performance of legacy access terminals (e.g., access terminals that are not configured to acquire the cell information).

For example, a physical channel may normally convey certain information via a steady state variable (e.g., by setting a bit to a 1 or −1 value). In such a case, in accordance with the teachings herein, the value of that variable may be modified (e.g., on a slot-by-slot basis) based on the cell information. Thus, an access terminal that is configured to acquire cell information from the physical channel will be able to determine the cell information that was modulated onto that variable.

However, it is desirable to ensure that a legacy access terminal that is not configured to acquire cell information from the physical channel will still be able to determine the original steady state value of the variable. To address this issue, the encoding scheme for the cell information is selected to ensure (or substantially ensure) that upon extracting the variable from the physical channel, the legacy access terminal will derive the intended steady state value.

In some implementations, a legacy access terminal determines the value of such a variable based on the value that occurs most frequently in a series of instances of the variable received by the access terminal. For example, if the value +1 occurs more frequently than the value −1 in a series of bits received at the access terminal, the access terminal will determine that the bit represents a +1.

In such a case, the encoding method for the cell information may ensure that the intended steady state value occurs most often in a set of the variable values after the variable has been modulated by the cell information. For example, assume the variable consists of a bit and the intended steady state value is +1. In this case, the encoding may ensure that the cell information is encoded in such a way that after the bit is modulated by the encoded cell information, that the resulting set of bits will have more +1 s than −1s. One technique for ensuring this is by including one or more bits in the set that are not part of the identifier but are instead used to change the weighting of the set (e.g., by adding more +1s or −1 s as needed).

A specific example of the above is described below for a case where the physical channel is a UMTS synchronization channel. In this example, a space time block coding-based transmit antenna diversity (STTD) bit in sent in every slot of the synchronization channel. Here, if the STTD bit equals +1, the presence of STTD is indicated. Conversely, if the STTD bit equals −1, the absence of STTD is indicated. In accordance with the teachings herein, the STTD bit may be modulated to send cell information. In particular, the STTD bit is modulated based on the cell information. In this case, the encoding method will encode the cell information to provide a codeword. Moreover, the encoding method will ensure that the resulting codeword that is used to modulate the STTD bit will decode to the defined (i.e., intended) STTD value by a legacy access terminal. For example, as discussed above, the encoding method may append one or more bits to the codeword to ensure that the codeword is of the appropriate weight (e.g., more +1 s than −1 s).

After the encoding of the cell information (e.g., as discussed immediately above), the resulting codeword is used to modulate the physical channel. Here, a spreading code, a scrambling code, or some other code may be defined for the channel, whereby any information sent over the physical channel is modulated by this code. The resulting signal is then transmitted by the access point on a designated carrier frequency or several designated carrier frequencies.

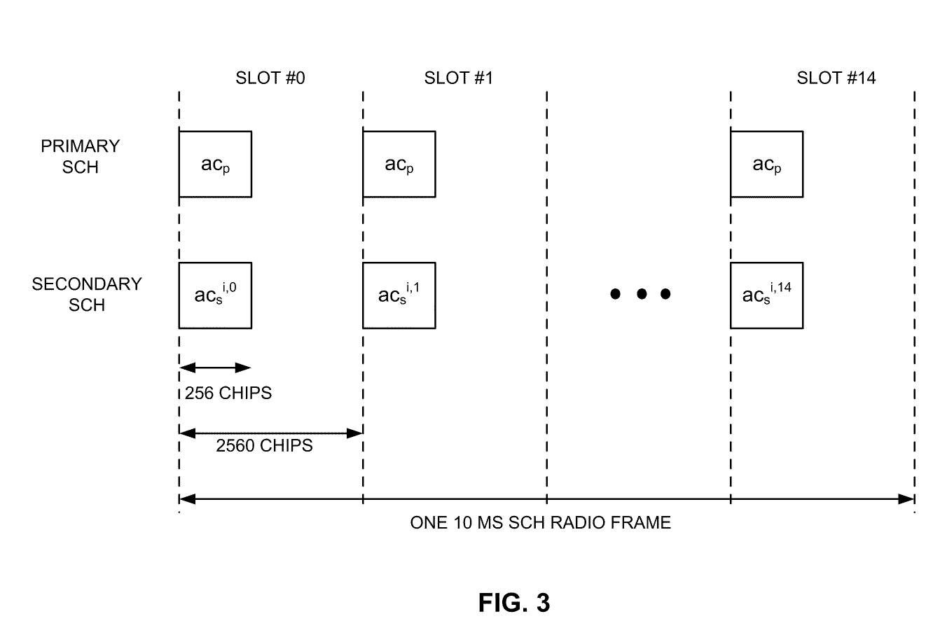

The cell information may be transmitted on various types of physical carriers. As described below in conjunction with FIGS. 3-6, in some implementations cell information is transmitted on one or more synchronization channels. In other implementations, cell information may be sent on some other type of physical channel.

For example, an access point may send cell information on a dedicated physical channel. In this case, a specific code (e.g., chip sequence) may be assigned for modulating the cell information sent via this channel. Such a channel may be transmitted continuously, periodically, sporadically, or in some other manner. In some cases, the code may be scrambled with the access point's PSC. In some cases, the code may comprise an indication that the channel includes cell information (e.g., certain codes are assigned specifically for cell information physical channels). In some cases, each code in the system may be uniquely assigned to a specific access point. Also, the code for a given access point may be orthogonal to other codes used by the access point.

An access point may transmit cell information on its operating carrier frequency and/or at least one other carrier frequency. For example, a femto cell may normally operate on a given carrier frequency (hereafter referred to as the femto frequency). Depending on the implementations, macro cells also may be operating on the femto frequency. In addition, at least one neighboring macro cell may be operating on at least one other carrier frequency (hereafter referred to as the macro frequencies). In such a case, the femto cell may transmit its cell information on the femto frequency (e.g., to attract home access terminals operating on that frequency). In addition, the femto cell may transmit its cell information on the macro frequencies (e.g., to attract home access terminals operating on those frequencies).

In some cases, the cell information may be transmitted through a beacon. For example, an access point operating on a particular frequency may transmit cell information (which may contain information specific to the access point's operating frequency) on another carrier as part of a beacon signal. Thus, in some aspects, a modulated RF physical channel may be part of a beacon signal transmitted on a frequency other than the frequency used by the access point.

Cell information transmission across macro frequencies may be accomplished in various ways depending on the transmission capabilities of the access point. For example, cell information may be continuously transmitted across macro frequencies if the access point has multiple transmission chains available for these transmissions. As another example, cell information may be transmitted in a frequency hopping fashion if the access point has one transmission chain available for these transmissions. If the access terminal does not have any additional transmission chains available for the transmission of cell information across macro frequencies, these transmissions may be time-shared with the access point's downlink transmissions. Also, for interference mitigation purposes, the access point may transmit the cell information intermittently and/or temporarily turn off these transmissions. Furthermore, the transmission power used for these transmissions may be controlled (e.g., for interference mitigation purposes).

As represented by block 206 of FIG. 2, an access terminal in the vicinity of the access point will receive the RF physical channel signals that are modulated based on the cell information of the access point as discussed above. As discussed in more detail below, for the case of a synchronization channel, this may involve synchronizing to the channel (e.g., achieving slot synchronization, then frame synchronization).

The access terminal may receive these signals in an intra-frequency scenario (e.g., the access terminal's current operating frequency with its serving access point) or an inter-frequency scenario. In the latter case, appropriate compressed mode measurements may be employed on the other frequencies to mitigate potential disruption on the access terminal's operating frequency caused by tuning away from that frequency.

As represented by block 208, the access terminal derives the cell information by demodulating the received signals. For example, the access terminal will use the code designated for that physical channel (e.g., the synchronization code for a synchronization channel) to acquire the information from that channel.

In an implementation where the cell information is encoded before transmission (e.g., as discussed above at block 204), the access terminal decodes the received codeword using the corresponding decoding process or processes. In this case, the result of the decoding thus provides the original cell information (e.g., cell ID and/or CSG ID).

As represented by block 210, the access terminal then performs an operation based on the cell information. Several examples of such operations will now be described in detail.

In some implementations, the cell information is used for idle mode or active mode mobility procedures. Here, an access terminal may decode the cell information from a physical channel and take appropriate steps toward mobility management. For example, for active hand-in, a cell ID and/or a CSG ID decoded from the physical channel may be used to resolve a femto cell disambiguation problem for UMTS Rel. 9 or higher access terminals. For idle reselection, a UMTS Rel. 7 or higher access terminal may read CSG information for a cell from the physical channel to perform access control. Advantageously, the access terminals may acquire this information without decoding SIB messages. Consequently, such a scheme may acquire the cell information relatively quickly (e.g., on the order of 100 ms or less) and thereby mitigate degradations in network performance that could otherwise occur in conjunction with decoding SIB messages.

In some implementations, the cell information is used for access point identification and interference management purposes. For example, when an access terminal that is not authorized to access a femto cell (e.g., a so-called non-allowed access terminal) is in an active call on a macro network and is in the vicinity of a femto cell, the non-allowed access terminal may be subject to downlink interference from the femto cell. In such a case, the non-allowed access terminal may quickly decode cell information (e.g., an identifier) received from the interfering femto cell on a physical channel and report this cell information to the macro network. The macro network may then enable interference management procedures (e.g., through a femto cell management server or a femto cell gateway) based on this cell information. Examples of such interference management methods include adjusting or throttling femto cell transmit power and/or beacon transmit power.

In some implementations, the cell information is used to provide location-based services. For example, cell information transmitted via a physical channel may be used to develop a finger-printing database at an access terminal, at a macro access point, or at a femto cell network. Here, the term finger-printing represents that in some aspects, the reception of signals from a certain set of access points provides an indication that the access terminal is at a certain location.

Referring now to FIGS. 3-5, for purposes of illustration, an example of how cell information may be transmitted over a UMTS primary synchronization channel and/or a UMTS secondary synchronization channel will be described. In conjunction with these figures, examples of physical layer channels, modulation schemes, encoding schemes, and decoding schemes that may be employed in conjunction with the teachings herein are described. It should be appreciated that the described techniques may be applicable to other types of communication technologies, physical channels, modulation schemes, and decoding schemes.

FIG. 3 illustrates an example of a synchronization channel in UMTS. A 10 ms radio frame on the downlink is divided into 15 slots, where each slot has a length of 2560 chips.

The initial acquisition/synchronization procedure in UMTS is a three step procedure. The first step involves slot synchronization. The second step involves frame synchronization and code group identification. The third step involves scrambling code identification.

The initial acquisition starts by acquiring the slot boundary in a 10 ms radio frame. This is achieved by searching the primary synchronization channel (P-SCH). The P-SCH consists of a 256 chip sequence (Cp), called the primary synchronization code, that is transmitted once every slot. The symbol ‘a’ indicates the presence of space time block coding-based transmit antenna diversity (STTD). As mentioned above, ‘a’ equal to +1 indicates the presence of STTD, and ‘a’ equal to −1 indicates the absence of STTD. The chip sequence (Cp) is the same for every cell.

The next step is acquiring the secondary synchronization channel (S-SCH). The S-SCH is chip sequence Cₛ^{i,k} where i=1, . . . , 63 denotes the number of the scrambling code group, and k=1, . . . , 14 denotes the slot number. In this step, the access terminal determines the code group and achieves frame synchronization.

Once the code group on the S-SCH channel is identified and frame boundary established, the access terminal identifies the primary scrambling code used by the access point to modulate the common pilot channel (CPICH). The CPICH carries a known symbol sequence and is scrambled by the PSC. There are eight PSCs per code group. The access terminal tries the eight combinations on the CPICH to identify the PSC used by the access point.

In this example, the access point transmits cell information such as cell ID or CSG ID on the downlink by modulating the cell information by the primary synchronization code and/or the secondary synchronization code over the appropriate synchronization channel. As discussed above, however, in other cases, the access point may transmit the cell information on an additional physical layer channel.

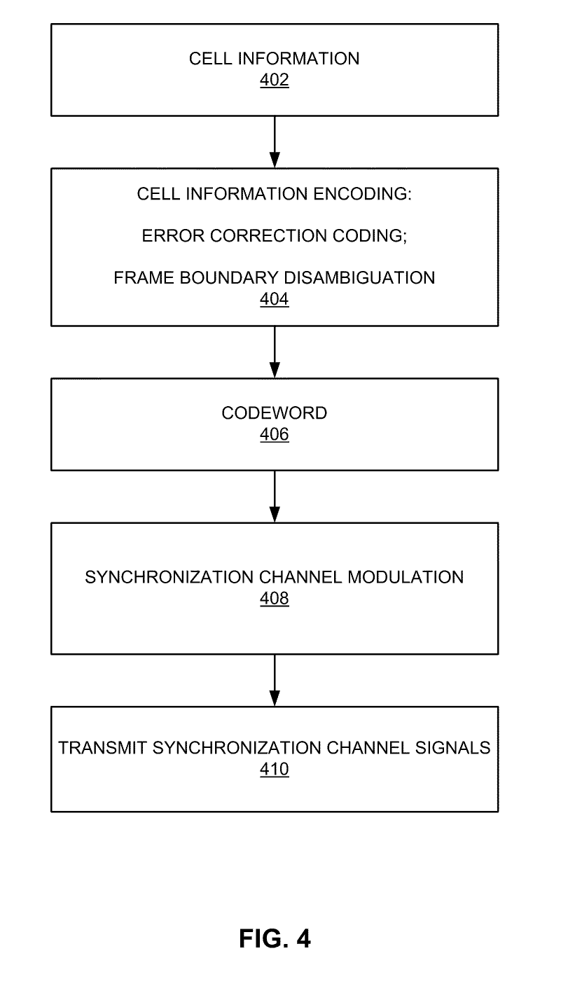

FIG. 4 describes sample operations that may be performed by an access point to modulate cell information on a synchronization channel. For example, the cell information may be encoded and modulated by the primary synchronization code (Cp), and transmitted on the downlink. Cell information may be sent over multiple frames. In addition, bits of cell information are protected by codes for boundary disambiguation and channel errors as discussed herein. Except where stated, the following operations apply to transmissions on the access point's operating frequency (e.g., a femto cell frequency) or on another frequency (e.g., a macro frequency).

As represented by block 402, cell information is provided as an input to a cell information encoding process.

As represented by block 404, the cell information encoding process may involve error correction encoding and/or frame boundary disambiguation. These operations may be performed in either order.

In some implementations, the error correction coding is performed first. For example, an error correcting code may be applied to the cell information, thereby generating an initial codeword. Frame boundary disambiguation may then be applied to the initial codeword to provide a final codeword.

Conversely, in other implementations, the frame boundary disambiguation is performed first. For example, frame boundary disambiguation may be applied to the cell information, thereby generating an initial codeword. An error correcting code may then be applied to the initial codeword to provide a final codeword.

As mentioned above, frame boundary disambiguation may need to be employed in cases where the cell information (e.g., the codeword) may span multiple frames. As discussed above, this may involve, for example, the use of at least one of: choosing a codeword with an acyclic property, inserting a start-of-frame delimiter and/or an end-of-frame delimiter, or using certain properties of a CRC function.

Also, as discussed above, techniques may be employed to ensure that the STTD indication bit (the variable ‘a’ in FIG. 3) can be reliably decoded by access terminals (including legacy access terminals). To achieve this, in some implementations, the codewords are designed with the following constraints: 1) codewords with weights greater than x percentile are transmitted if STTD is off; 2) codewords with weights less than y percentile weight are transmitted if STTD is on.

An example of a scheme for providing a codeword that ensures that the STTD bit may be reliably decoded follows. Here, one or more bits that will be ignored at the access terminal are appended to the cell information. Two cell information instances are then generated, with the added bits set differently in each instance. Each instance is then run through the encoder (e.g., error correction encoding, etc). One of the resulting codewords will have the desired property to ensure that the STTD bit may be reliably decoded. This codeword is therefore selected for transmission over the physical channel.

Note, however, that the STTD issue need not be addressed in all cases. For example, in cases where the access point is transmitting its cell information on a frequency other than the access point's operating frequency (e.g., where a femto cell is transmitting on a macro frequency), the STTD requirement need not be addressed since the access point will not transmit any other channels on this frequency.

As represented by block 406, the codeword output by the cell information encoding process is provided as an input to a synchronization channel modulation process.

As represented by block 408, the synchronization channel modulation process uses a synchronization code to modulate the codeword. For transmission via the primary synchronization channel, the codeword is modulated by the primary synchronization code. For transmission via the secondary synchronization channel, the codeword is modulated by the secondary synchronization code.

As represented by block 410, the access point then transmits the synchronization channel signals including the modulated codeword. As discussed, above, the synchronization channel may be transmitted intra-frequency or inter-frequency.

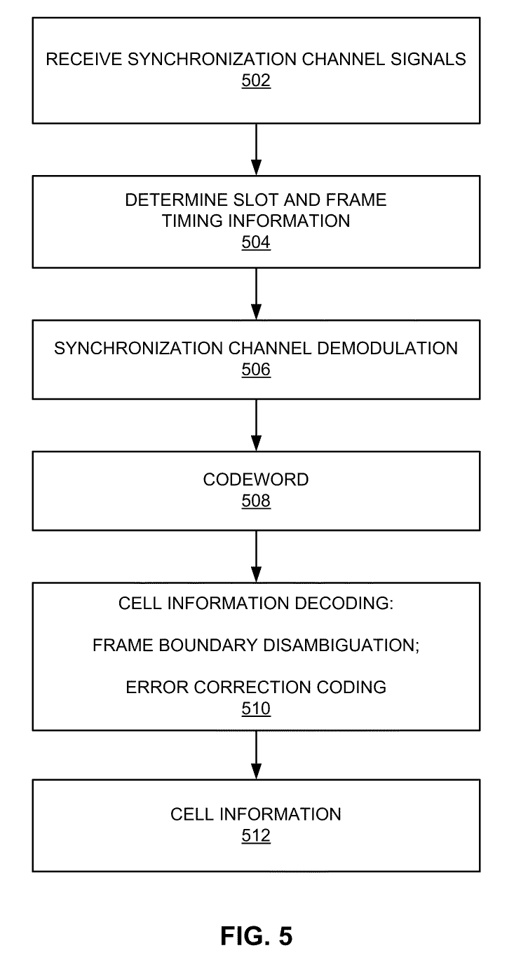

FIG. 5 describes sample operations that may be performed by an access terminal (e.g., a non-legacy access terminal) that is configured to acquire cell information via a synchronization channel. As represented by block 502, the access terminal receives the synchronization channel signals on a given carrier frequency.

As represented by block 504, the access terminal determines the slot and frame timing information. For example, the access terminal may obtain cell timing information through the three step synchronization procedure discussed above.

As represented by block 506, once synchronization is acquired, the received signals are demodulated. As discussed above, this may involve identifying the values of the STTD bits in the synchronization channel. For example, upon determining the slot synchronization, the frame synchronization, and the code group identification, the resulting information derived from the received STTD bits may comprise the codeword.

As represented by block 508, upon completing the synchronization process, the resulting codeword is provided as an input to a cell information decoding process.

As represented by block 510, the cell information decoding process may involve error correcting decoding (e.g., error correction decoding) and/or frame boundary disambiguation operations that are complementary to the operations described above at block 404. These operations may be performed in either order, depending on the order of the operations at block 404. In implementations where the error correction encoding was performed first at block 404, the error correction decoding may be performed last at block 510, and vice versa. As discussed herein, the frame boundary disambiguation may involve identifying one or more delimiters to identify a frame boundary, or identifying a received CRC checksum to identify a frame boundary.

As represented by block 512, the result of the cell information decoding process is the original cell information. The access terminal may then use this derived cell information (e.g., to perform mobility, interference, and finger-printing procedures as discussed herein).

The operations performed by an access terminal (e.g., as described at FIG. 5) may be different for the case where a femto cell transmits cell information on a femto frequency as compared to the case where the femto cell transmits cell information on a macro frequency. For example, on the femto frequency, the femto cell may use a primary scrambling code (PSC) to transmit its service channel. Hence, in this case, the access terminal may derive the femto cell's PSC information.

Conversely, a femto cell may only transmit cell information on a macro frequency. That is, the femto cell may not transmit any other information the macro frequency (e.g., the femto cell may not transmit a common pilot channel (CPICH) or any other channels). Consequently, it may be sufficient for the femto cell to transmit just the synchronization channels (e.g., P-SCH and S-SCH) carrying the cell information.

In this case, the access terminal need not acquire the femto cell's PSC (although it may do so anyway in some implementations). Hence, upon completing the slot-level (and/or frame-level) synchronization, the access terminal may simply proceed with decoding the cell information. Moreover, the STTD requirement need not be addressed in this case since no other channels are transmitted on the macro frequency.

As discussed herein, any legacy access terminals that receive the synchronization channel transmitted by the access point will not be able to decode the cell information. However, for the case where a femto cell is transmitting on the femto frequency, since the structure of the synchronization is not changed, the performance is not affected. Here, the impact on legacy access terminal decoding of the STTD bit is minimized by the choice of codewords with weight restriction.

For the case where a femto cell is transmitting on a macro frequency, the synchronization channel sent on the downlink of the femto cell will appear as interference to non-allowed legacy access terminals that are connected (i.e., in active call) to a macro access point (e.g., a Node B) in the vicinity of the femto cell. However, the performance impact on a voice call is minimal, since the downlink dedicated physical channel (DPCH) is power controlled and the voice frames are convolutionally coded and block interleaved. Again, the STTD requirement need not be addressed in this case since no other channels are transmitted on the macro frequency.

As mentioned above, the teachings herein may be advantageously employed for mobility procedures. Sample mobility procedure for active hand-in and idle cell reselection will now be described in more detail.

When an access terminal user gets close to a femto cell (e.g., a scenario where a cellular subscriber is coming home), it may be desired to enable handover to that particular femto cell. The process of hard handoff from macro cell coverage to femto cell coverage during an active call (e.g., the access terminal is in Cell DCH state) is referred to as “active hand-in”.

For intra-frequency hand-in, when an access terminal is connected to a macro node B, as the access terminal user gets close to a femto cell, the access terminal performs an initial acquisition procedure and acquires cell timing. In addition, the access terminal also decodes the physical layer ID present on the synchronization channel. It then reports the presence of the femto cell to the macro RNC via standard measurement report messages such as Event 1a. The macro RNC then facilitates intra-frequency hard hand-in.

More precisely, the intra-frequency hard hand-in procedure involves the two steps that follow. As a first step, the macro RNC includes the femto cell's PSC in the NCL of the measurement control message (MCM). As a second step, the access terminal takes intra-frequency measurements on the femto cells in the NCL. Also, the access terminal decodes the physical layer ID. Intra-frequency measurements and the physical layer ID are included in the measurement report message (MRM), which is sent to the macro RNC. On receiving the MRM (e.g., Event 1a) that indicates detection of a femto cell PSC, and cell information (e.g., physical layer ID), a macro RNC may initiate the intra-frequency hard hand-in procedure.

Advantageously, the proposed method does not require access terminals to read MIBs or SIBs. Hence, there is no wait-time involved in receiving and decoding of SIB messages. The method thus shortens the time required for the hard hand-in procedure.

For inter-frequency hand-in, when an access terminal is connected to a macro node B in frequency f1, as the access terminal user gets close to a femto cell on f2, the access terminal performs step 1 and/or step 2 acquisition and acquires slot and/or frame timing. In addition, the access terminal decodes the physical layer ID on the synchronization channel. It then reports the presence of the femto cell to the macro RNC. The macro RNC then facilitates inter-frequency hard hand-in. This may involve an immediate trigger of inter-frequency handover or compressed mode inter-frequency handover.

Again, the proposed method does not require access terminals to read MIBs or SIBs. Hence, there is no wait-time involved in receiving and decoding of SIB messages. The method thus shortens the time required for the hard hand-in procedure.

When, an access terminal in idle mode camping on a macro Node B approaches a femto cell, it is desired that the access terminal reselects and camps on the femto cell. The process of finding the femto cell is referred to as femto cell discovery. A fundamental issue arises in the femto cell discovery process when multiple frequencies are available in the macro network. To illustrate the issue, consider a scenario where an access terminal is camping on a macro Node B on frequency f1 and a femto cell is on f2. If the access terminal is in good macro coverage (i.e., macro signal quality is better than the thresholds required to trigger searches and reselection), the access terminal will remain camping on the macro. As a consequence, the access terminal may never discover the femto cell.

The proposed-method may facilitate idle cell reselection as follows. When an access terminal is camping on a macro Node B (on f1), as the access terminal user gets close to a femto cell (on f2) the access terminal acquires slot and frame timing of the synchronization channels sent on f1. In addition, the access terminal decodes the physical layer ID present on the synchronization channel. The access terminal may thus perform access control on the CSG ID. If the access terminal is allowed on the cell, then it may search and measure the femto cell on f2. If the access terminal is not allowed access, it may remain camping on the macro Node B on f1.

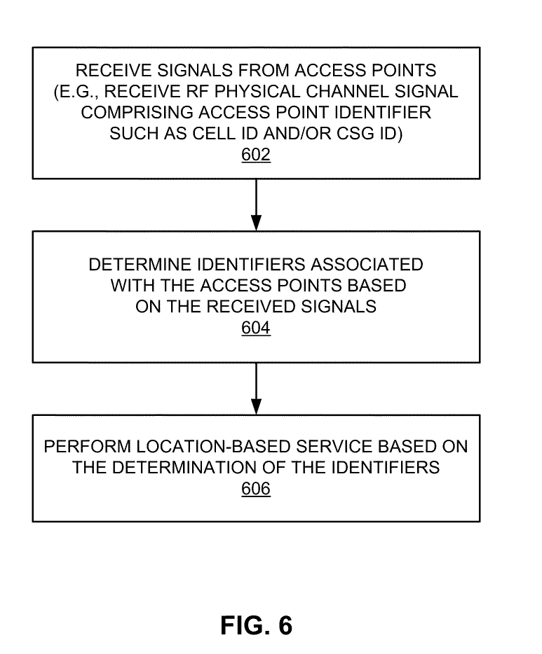

FIG. 6 illustrates sample operations that may be performed by an access terminal to provide a location-based service based on identifiers the access terminal receives via signals from access points. For example, an access terminal may maintain a database (or connection network) that associates certain services with certain locations. Moreover, the locations in the database may be defined by or associated with the presence of certain access points at each location. For example, if an access terminal receives signals from a specified set of access points (on one or more carrier frequencies), the access terminal will determine that it is in a certain location.

As a specific example, a user may build a database entry that includes the cell IDs of the access points (e.g., femto cells and/or macro cells) that are close to the user's home. Then, when the user's access terminal approaches the user's home, the access terminal will detect this situation based on the set of cell IDs received by the access terminal. Thus, the access terminal may determine that it is in the vicinity of a specific access point (e.g., a Home Node B) based on the received identifiers. The access terminal may then take any action specific (e.g., initiate a specified type of communication) for this location. For example, the access terminal may tune to the femto cell frequency (e.g., conduct an inter-frequency search) to find the user's femto cell.

As another example, when a user enters a shopping mall, the identification of the access points associated with the shopping mall may invoke a specific action by the access terminal. In some implementations, the access terminal displays information associated with the location via a user interface of the access terminal. For example, the access terminal may present specific advertisements to the user. In some implementations, the access terminal sends an indication of its location to a network (e.g., upon sending location information to an access point at the mall, the access terminal receives advertising information from that access point).

A location determination may be based on a set of access point identifiers or a sequence of access point identifiers. As an example of the latter case, the access terminal may determine a direction from which the access terminal is approaching a particular location based on the order in which the access terminal sees the access points.

In some aspects, a location determination may be based on the signal strengths of the signals the access terminal receives from the access point. For example, a given location may be defined by a strong signal (e.g., within threshold limits) from one access point and a weak signal (e.g., within threshold limits) from another access point.

The access terminal may acquire the database in various ways. In some cases, a network entity (e.g., a femto management server or some other type of configuration server) may configure the access point with the database. In addition, or alternatively, the access point may learn location information on its own as its travels through a network.

Referring now to the operations of FIG. 6, as represented by block 602, at some point in time, an access terminal receives signals from access points. In some implementations, these signals may comprise RF physical channel signals including cell information (e.g., an identifier such as a cell ID and/or a CSG ID). Other types of signals (e.g. pilot signals, beacon signals, SIB messages) may be received in other implementations.

As represented by block 604, the access terminal determines identifiers associated with the access points based on the received signals. For example, the access terminal may derive the cell ID of a first access point based on the cell information included in a physical channel transmitted by the first access point, derive the cell ID of a second access point based on the cell information included in a physical channel transmitted by the second access point, and so on.

As represented by block 606, the access terminal performs location-based service based on the determination of block 604. For example, upon determining that identifiers of the first and second access points have been received, the access terminal may perform a database lookup and determine that a specific service is to be provided at that location. A wide variety of services may be provided in this manner. Several examples of such services are set forth below. These services may be invoked, for example, in the event a single access point (or cell) is identified (e.g., the set has a single entry), or in the event multiple access points (or cells) are identified.

Some implementations may employ an active hand-in service. For example, upon identifying the designated set, an access terminal may initiate an active hand-in to a femto cell on the same or another carrier.

Some implementations may employ a service relating to femto cell discovery and battery life trade-off. For example, an access terminal in idle mode may increase the frequency of full search when the cell identification indicates that the access terminal is in the vicinity of a femto cell where the access terminal is allowed.

In some implementations, the access terminal (e.g., a smartphone device) may combine the cell identification/finger-print information with a database application classifying identified finger-print into categories. These categories are further used by different applications to trigger behaviors at the access terminal. Several examples of these categories and behaviors follow.

A category may relate to a type of business in the vicinity (e.g., a grocery store). Here, the corresponding behavior may be location-based reminders (e.g., reminding a user to get milk when in the vicinity of a grocery store).

A category may relate to a mode of operation towards battery savings. For example, when identified as near ‘home’, the access terminal switches off intensive applications (such as email synch) that are more useful at work. When identified to be near a workplace, the access terminal turns these applications back on.

A category may relate to a mode of operation towards social protocol. For example, when identified as near a theater, cinema, hospital, or library, the access terminal may change its ringer from loud to vibrate mode and also change the brightness of the screen. Additionally, this may involve turning off the radio itself, for example, on entering an airplane.

A category may relate to auto-scheduling of data sessions based on location. For example, large video download sessions are automatically initiated, but only when in the vicinity of the user's home. Secure data download and upload is automatically initiated only when in the vicinity of a work network.

A category may relate to turning on or off of sensors and integrated devices. For example, an access terminal may initiate automatically certain devices, such as cameras, or bio-sensors such as a heart-rate monitor based on an identified location category.

A category may relate to an alarm based on the absence of certain categories. Here, an access terminal may alarm the user when the identified finger-print/identification does not belong to specified categories. For example, this may be used to indicate trespassing on private property or unknowingly crossing an international border.

The teachings herein may be incorporated into different types of apparatuses in different implementations. For example, in some cases, an access point will transmits its cell information via a physical channel. In addition, or alternatively, in some cases, another entity (e.g., apparatus) that is not co-located with the access point may transmit the cell information for the access point via a physical channel. For example, a femto cell user may deploy a femto at one location in the user's house (e.g., to provide optimal coverage throughout the house). In addition, the user may deploy another apparatus that transmits the cell information for an access point via a physical channel at another location in the house (e.g., near an entrance). In this way, when the user's access terminal approaches the house, the access terminal will readily acquire this information (e.g., to enable quicker hand-in to the user's femto cell).

In view of the above, a method and framework are provided to embed cell specific information on physical layer channels of an access point (e.g., a node B). In some aspects, cell specific information sent on the physical layer comprises a physical layer ID. The disclosed techniques facilitate mobility, interference management and finger-printing procedures in femto cell deployed cellular networks and other networks. Advantageously, the disclosed techniques allow access terminals to read cell specific information quickly without having to wait for SIB messages. Moreover, these techniques enable fast hard handover, result in minimal or no frame errors, can avoid frequent compressed mode measurements, and may have minimal or no impact on the standby time of idle mode access terminals.

FIG. 7 illustrates several sample components (represented by corresponding blocks) that may be incorporated into nodes such as an access point 702 and an access terminal 704 (e.g., corresponding to the access point 104 and the access terminal 102 of FIG. 1, respectively) to perform physical channel-related operations as taught herein. The described components also may be incorporated into other nodes in a communication system. For example, other nodes in a system may include components similar to those described for the access point 702 to provide similar functionality. Also, a given node may contain one or more of the described components. For example, an access terminal may contain multiple transceiver components that enable the access terminal to operate on multiple carriers and/or communicate via different technologies.

As shown in FIG. 7, the access point 702 and the access terminal 704 each include one or more transceivers (as represented by the transceiver 706 and the transceiver 708, respectively) for communicating with other nodes. Each transceiver 706 includes a transmitter 710 for sending signals (e.g., physical channel signals, cell information, messages) and a receiver 712 for receiving signals (e.g., messages). Similarly, each transceiver 708 includes a transmitter 714 for sending signals (e.g., messages) and a receiver 716 for receiving signals (e.g., physical channel signals, messages).

The access point 702 also includes a network interface 718 for communicating with other nodes (e.g., other network entities). The network interface 718 may be configured to communicate with one or more network entities via a wire-based or wireless backhaul. In some aspects, the network interface 718 comprise transceiver components (e.g., transmitter and receiver components) configured to support wire-based communication or wireless communication. Accordingly, in the example of FIG. 7, the network interface 718 is shown as including a transmitter 720 for sending signals (e.g., messages) and a receiver 722 for receiving signals (e.g., messages).

The access point 702 and the access terminal 704 also include other components that may be used in conjunction with physical channel-related operations as taught herein. For example, the access point 702 includes a controller 724 for controlling the transmission of cell information over a physical channel (e.g., identifying cell information associated with the access point 702) and for providing other related functionality as taught herein. In some implementations, functionality of the controller 724 may be implemented in the transceiver 706. The access terminal 704 includes a controller 726 for controlling the receipt of cell information over a physical channel and/or for performing location-based service operations (e.g., deriving cell information by demodulating RF physical channel signals, performing an operation based on derived call information, determining identifiers associated with access points based on received signals, performing a location-based service) and for providing other related functionality as taught herein. In some implementations, functionality of the controller 726 may be implemented in the transceiver 708. The access point 702 and the access terminal 704 include memory components (e.g., including memory devices) 728 and 730 for maintaining information (e.g., cell information, database information).

For convenience the access point 702 and the access terminal 704 are shown in FIG. 7 as including components that may be used in the various examples described herein. In practice, one or more of the illustrated components may be used in a different manner in different implementations. As an example, the functionality of the block 726 may be different in an embodiment implemented in accordance with FIG. 2 as compared to an embodiment implemented in accordance with FIG. 6.

The components of FIG. 7 may be implemented in various ways. In some implementations the components of FIG. 7 may be implemented in one or more circuits such as, for example, one or more processors and/or one or more ASICs (which may include one or more processors). Here, each circuit (e.g., processor) may use and/or incorporate data memory for storing information or executable code used by the circuit to provide this functionality. For example, some of the functionality represented by blocks 706 and 718 and some or all of the functionality represented by blocks 724 and 728 may be implemented by a processor or processors of an access point and data memory of the access point (e.g., by execution of appropriate code and/or by appropriate configuration of processor components). Similarly, some of the functionality represented by block 708 and some or all of the functionality represented by blocks 726 and 730 may be implemented by a processor or processors of an access terminal and data memory of the access terminal (e.g., by execution of appropriate code and/or by appropriate configuration of processor components).

As discussed above, in some aspects the teachings herein may be employed in a network that includes macro scale coverage (e.g., a large area cellular network such as a 3G network, typically referred to as a macro cell network or a WAN) and smaller scale coverage (e.g., a residence-based or building-based network environment, typically referred to as a LAN). As an access terminal (AT) moves through such a network, the access terminal may be served in certain locations by access points that provide macro coverage while the access terminal may be served at other locations by access points that provide smaller scale coverage. In some aspects, the smaller coverage nodes may be used to provide incremental capacity growth, in-building coverage, and different services (e.g., for a more robust user experience).

In the description herein, a node (e.g., an access point) that provides coverage over a relatively large area may be referred to as a macro access point while a node that provides coverage over a relatively small area (e.g., a residence) may be referred to as a femto access point. It should be appreciated that the teachings herein may be applicable to nodes associated with other types of coverage areas. For example, a pico access point may provide coverage (e.g., coverage within a commercial building) over an area that is smaller than a macro area and larger than a femto area. In various applications, other terminology may be used to reference a macro access point, a femto access point, or other access point-type nodes. For example, a macro access point may be configured or referred to as an access node, base station, access point, eNode B, macro cell, and so on. Also, a femto access point may be configured or referred to as a Home Node B, Home eNode B, access point base station, femto cell, and so on. In some implementations, a node may be associated with (e.g., referred to as or divided into) one or more cells or sectors. A cell or sector associated with a macro access point, a femto access point, or a pico access point may be referred to as a macro cell, a femto cell, or a pico cell, respectively.

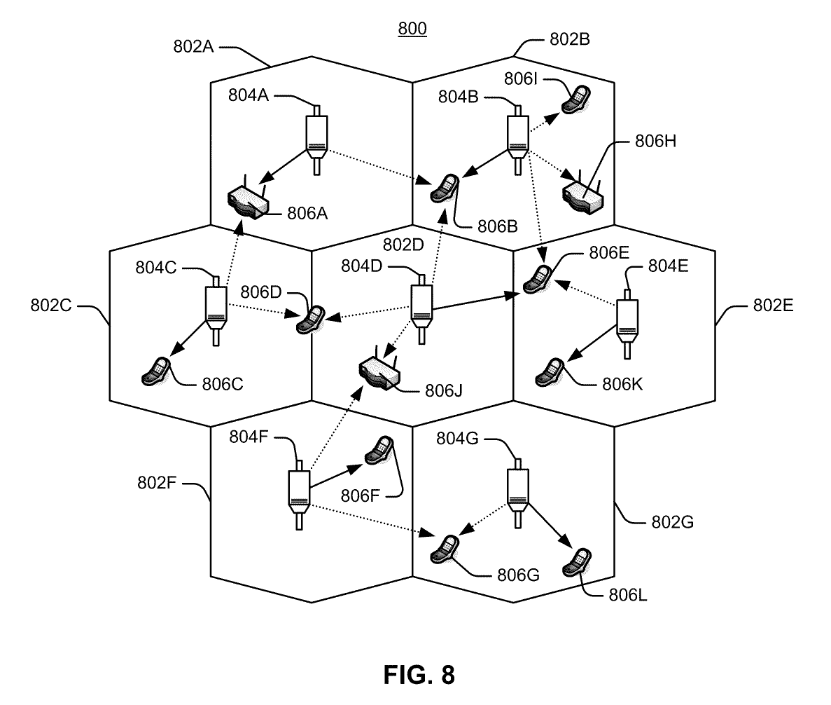

FIG. 8 illustrates a wireless communication system 800, configured to support a number of users, in which the teachings herein may be implemented. The system 800 provides communication for multiple cells 802, such as, for example, macro cells 802A-802G, with each cell being serviced by a corresponding access point 804 (e.g., access points 804A-804G). As shown in FIG. 8, access terminals 806 (e.g., access terminals 806A-806L) may be dispersed at various locations throughout the system over time. Each access terminal 806 may communicate with one or more access points 804 on a forward link (FL) and/or a reverse link (RL) at a given moment, depending upon whether the access terminal 806 is active and whether it is in soft handoff, for example. The wireless communication system 800 may provide service over a large geographic region. For example, macro cells 802A-802G may cover a few blocks in a neighborhood or several miles in a rural environment.

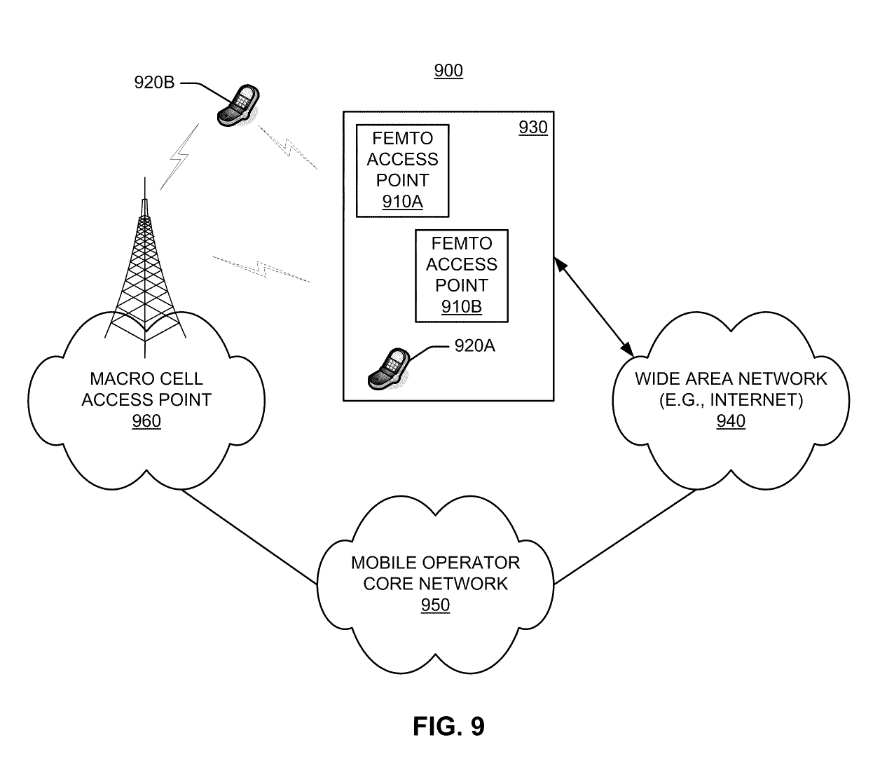

FIG. 9 illustrates an exemplary communication system 900 where one or more femto access points are deployed within a network environment. Specifically, the system 900 includes multiple femto access points 910 (e.g., femto access points 910A and 910B) installed in a relatively small scale network environment (e.g., in one or more user residences 930). Each femto access point 910 may be coupled to a wide area network 940 (e.g., the Internet) and a mobile operator core network 950 via a DSL router, a cable modem, a wireless link, or other connectivity means (not shown). As will be discussed below, each femto access point 910 may be configured to serve associated access terminals 920 (e.g., access terminal 920A) and, optionally, other (e.g., hybrid or alien) access terminals 920 (e.g., access terminal 920B). In other words, access to femto access points 910 may be restricted whereby a given access terminal 920 may be served by a set of designated (e.g., home) femto access point(s) 910 but may not be served by any non-designated femto access points 910 (e.g., a neighbor's femto access point 910).

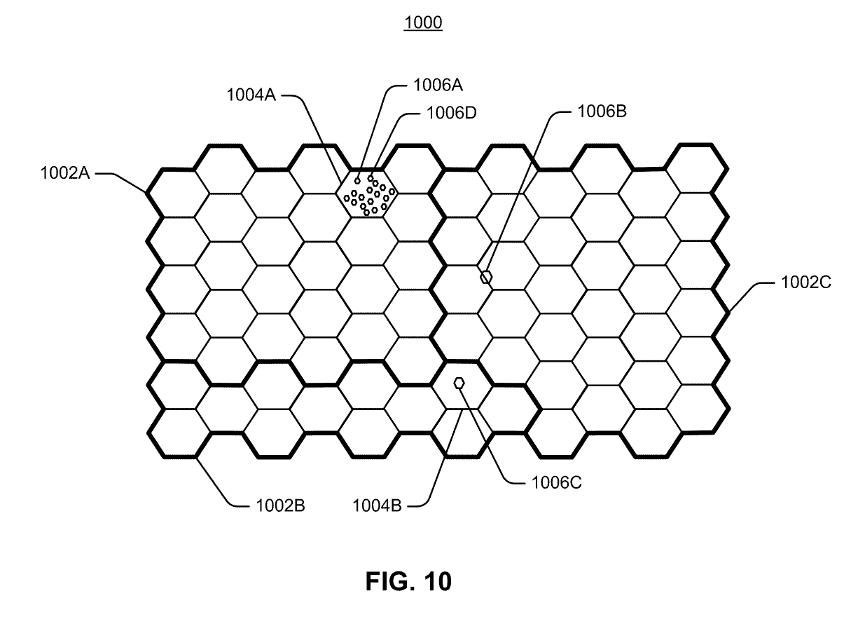

FIG. 10 illustrates an example of a coverage map 1000 where several tracking areas 1002 (or routing areas or location areas) are defined, each of which includes several macro coverage areas 1004. Here, areas of coverage associated with tracking areas 1002A, 1002B, and 1002C are delineated by the wide lines and the macro coverage areas 1004 are represented by the larger hexagons. The tracking areas 1002 also include femto coverage areas 1006. In this example, each of the femto coverage areas 1006 (e.g., femto coverage areas 1006B and 1006C) is depicted within one or more macro coverage areas 1004 (e.g., macro coverage areas 1004A and 1004B). It should be appreciated, however, that some or all of a femto coverage area 1006 may not lie within a macro coverage area 1004. In practice, a large number of femto coverage areas 1006 (e.g., femto coverage areas 1006A and 1006D) may be defined within a given tracking area 1002 or macro coverage area 1004. Also, one or more pico coverage areas (not shown) may be defined within a given tracking area 1002 or macro coverage area 1004.

Referring again to FIG. 9, the owner of a femto access point 910 may subscribe to mobile service, such as, for example, 3G mobile service, offered through the mobile operator core network 950. In addition, an access terminal 920 may be capable of operating both in macro environments and in smaller scale (e.g., residential) network environments. In other words, depending on the current location of the access terminal 920, the access terminal 920 may be served by a macro cell access point 960 associated with the mobile operator core network 950 or by any one of a set of femto access points 910 (e.g., the femto access points 910A and 910B that reside within a corresponding user residence 930). For example, when a subscriber is outside his home, he is served by a standard macro access point (e.g., access point 960) and when the subscriber is at home, he is served by a femto access point (e.g., access point 910A). Here, a femto access point 910 may be backward compatible with legacy access terminals 920.

A femto access point 910 may be deployed on a single frequency or, in the alternative, on multiple frequencies. Depending on the particular configuration, the single frequency or one or more of the multiple frequencies may overlap with one or more frequencies used by a macro access point (e.g., access point 960).

In some aspects, an access terminal 920 may be configured to connect to a preferred femto access point (e.g., the home femto access point of the access terminal 920) whenever such connectivity is possible. For example, whenever the access terminal 920A is within the user's residence 930, it may be desired that the access terminal 920A communicate only with the home femto access point 910A or 910B.

In some aspects, if the access terminal 920 operates within the macro cellular network 950 but is not residing on its most preferred network (e.g., as defined in a preferred roaming list), the access terminal 920 may continue to search for the most preferred network (e.g., the preferred femto access point 910) using a better system reselection (BSR) procedure, which may involve a periodic scanning of available systems to determine whether better systems are currently available and subsequently acquire such preferred systems. The access terminal 920 may limit the search for specific band and channel. For example, one or more femto channels may be defined whereby all femto access points (or all restricted femto access points) in a region operate on the femto channel(s). The search for the most preferred system may be repeated periodically. Upon discovery of a preferred femto access point 910, the access terminal 920 selects the femto access point 910 and registers on it for use when within its coverage area.

Access to a femto access point may be restricted in some aspects. For example, a given femto access point may only provide certain services to certain access terminals. In deployments with so-called restricted (or closed) access, a given access terminal may only be served by the macro cell mobile network and a defined set of femto access points (e.g., the femto access points 910 that reside within the corresponding user residence 930). In some implementations, an access point may be restricted to not provide, for at least one node (e.g., access terminal), at least one of: signaling, data access, registration, paging, or service.

In some aspects, a restricted femto access point (which may also be referred to as a Closed Subscriber Group Home Node B) is one that provides service to a restricted provisioned set of access terminals. This set may be temporarily or permanently extended as necessary. In some aspects, a Closed Subscriber Group (CSG) may be defined as the set of access points (e.g., femto access points) that share a common access control list of access terminals.

Various relationships may thus exist between a given femto access point and a given access terminal. For example, from the perspective of an access terminal, an open femto access point may refer to a femto access point with unrestricted access (e.g., the femto access point allows access to any access terminal). A restricted femto access point may refer to a femto access point that is restricted in some manner (e.g., restricted for access and/or registration). A home femto access point may refer to a femto access point on which the access terminal is authorized to access and operate on (e.g., permanent access is provided for a defined set of one or more access terminals). A hybrid (or guest) femto access point may refer to a femto access point on which different access terminals are provided different levels of service (e.g., some access terminals may be allowed partial and/or temporary access while other access terminals may be allowed full access). An alien femto access point may refer to a femto access point on which the access terminal is not authorized to access or operate on, except for perhaps emergency situations (e.g., 911 calls).

From a restricted femto access point perspective, a home access terminal may refer to an access terminal that is authorized to access the restricted femto access point installed in the residence of that access terminal's owner (usually the home access terminal has permanent access to that femto access point). A guest access terminal may refer to an access terminal with temporary access to the restricted femto access point (e.g., limited based on deadline, time of use, bytes, connection count, or some other criterion or criteria). An alien access terminal may refer to an access terminal that does not have permission to access the restricted femto access point, except for perhaps emergency situations, for example, such as 911 calls (e.g., an access terminal that does not have the credentials or permission to register with the restricted femto access point).

For convenience, the disclosure herein describes various functionality in the context of a femto access point. It should be appreciated, however, that a pico access point may provide the same or similar functionality for a larger coverage area. For example, a pico access point may be restricted, a home pico access point may be defined for a given access terminal, and so on.

The teachings herein may be employed in a wireless multiple-access communication system that simultaneously supports communication for multiple wireless access terminals. Here, each terminal may communicate with one or more access points via transmissions on the forward and reverse links. The forward link (or downlink) refers to the communication link from the access points to the terminals, and the reverse link (or uplink) refers to the communication link from the terminals to the access points. This communication link may be established via a single-in-single-out system, a multiple-in-multiple-out (MIMO) system, or some other type of system.

A MIMO system employs multiple (N_{T}) transmit antennas and multiple (N_{R}) receive antennas for data transmission. A MIMO channel formed by the N_{T} transmit and N_{R} receive antennas may be decomposed into N_{S} independent channels, which are also referred to as spatial channels, where Nₛ≦min{N_{T}, N_{R}}. Each of the N_{S} independent channels corresponds to a dimension. The MIMO system may provide improved performance (e.g., higher throughput and/or greater reliability) if the additional dimensionalities created by the multiple transmit and receive antennas are utilized.

A MIMO system may support time division duplex (TDD) and frequency division duplex (FDD). In a TDD system, the forward and reverse link transmissions are on the same frequency region so that the reciprocity principle allows the estimation of the forward link channel from the reverse link channel. This enables the access point to extract transmit beam-forming gain on the forward link when multiple antennas are available at the access point.

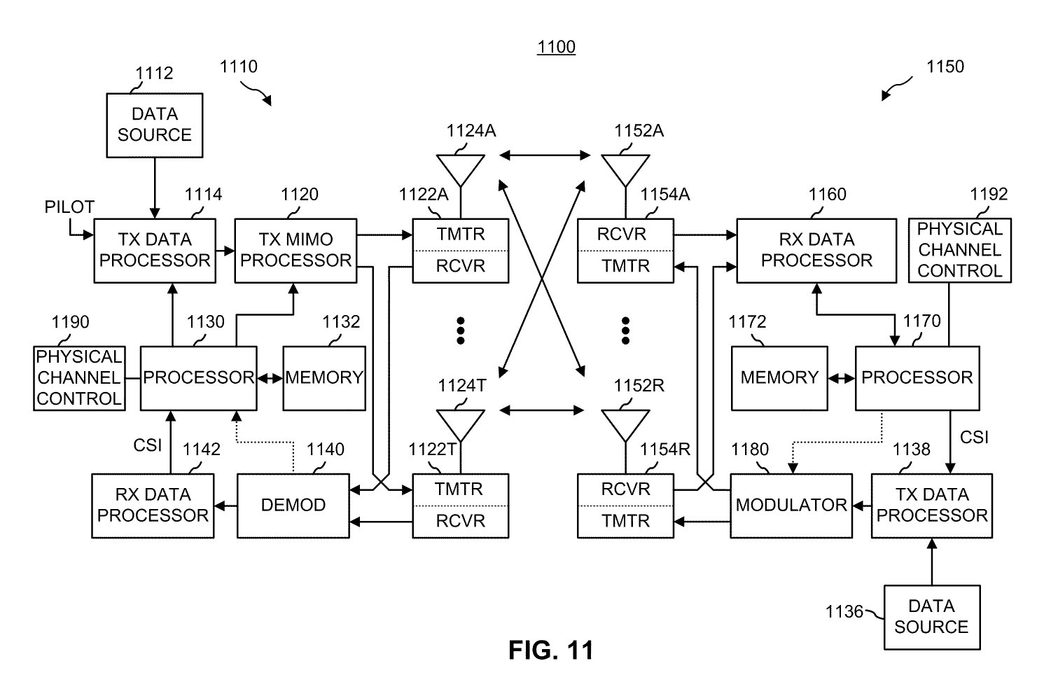

FIG. 11 illustrates a wireless device 1110 (e.g., an access point) and a wireless device 1150 (e.g., an access terminal) of a sample MIMO system 1100. At the device 1110, traffic data for a number of data streams is provided from a data source 1112 to a transmit (TX) data processor 1114. Each data stream may then be transmitted over a respective transmit antenna.

The TX data processor 1114 formats, codes, and interleaves the traffic data for each data stream based on a particular coding scheme selected for that data stream to provide coded data. The coded data for each data stream may be multiplexed with pilot data using OFDM techniques. The pilot data is typically a known data pattern that is processed in a known manner and may be used at the receiver system to estimate the channel response. The multiplexed pilot and coded data for each data stream is then modulated (i.e., symbol mapped) based on a particular modulation scheme (e.g., BPSK, QSPK, M-PSK, or M-QAM) selected for that data stream to provide modulation symbols. The data rate, coding, and modulation for each data stream may be determined by instructions performed by a processor 1130. A data memory 1132 may store program code, data, and other information used by the processor 1130 or other components of the device 1110.

The modulation symbols for all data streams are then provided to a TX MIMO processor 1120, which may further process the modulation symbols (e.g., for OFDM). The TX MIMO processor 1120 then provides N_{T} modulation symbol streams to N_{T} transceivers (XCVR) 1122A through 1122T. In some aspects, the TX MIMO processor 1120 applies beam-forming weights to the symbols of the data streams and to the antenna from which the symbol is being transmitted.

Each transceiver 1122 receives and processes a respective symbol stream to provide one or more analog signals, and further conditions (e.g., amplifies, filters, and upconverts) the analog signals to provide a modulated signal suitable for transmission over the MIMO channel. N_{T} modulated signals from transceivers 1122A through 1122T are then transmitted from N_{T} antennas 1124A through 1124T, respectively.

At the device 1150, the transmitted modulated signals are received by N_{R} antennas 1152A through 1152R and the received signal from each antenna 1152 is provided to a respective transceiver (XCVR) 1154A through 1154R. Each transceiver 1154 conditions (e.g., filters, amplifies, and downconverts) a respective received signal, digitizes the conditioned signal to provide samples, and further processes the samples to provide a corresponding “received” symbol stream.

A receive (RX) data processor 1160 then receives and processes the N_{R} received symbol streams from N_{R} transceivers 1154 based on a particular receiver processing technique to provide N_{T} “detected” symbol streams. The RX data processor 1160 then demodulates, deinterleaves, and decodes each detected symbol stream to recover the traffic data for the data stream. The processing by the RX data processor 1160 is complementary to that performed by the TX MIMO processor 1120 and the TX data processor 1114 at the device 1110.

A processor 1170 periodically determines which pre-coding matrix to use (discussed below). The processor 1170 formulates a reverse link message comprising a matrix index portion and a rank value portion. A data memory 1172 may store program code, data, and other information used by the processor 1170 or other components of the device 1150.

The reverse link message may comprise various types of information regarding the communication link and/or the received data stream. The reverse link message is then processed by a TX data processor 1138, which also receives traffic data for a number of data streams from a data source 1136, modulated by a modulator 1180, conditioned by the transceivers 1154A through 1154R, and transmitted back to the device 1110.

At the device 1110, the modulated signals from the device 1150 are received by the antennas 1124, conditioned by the transceivers 1122, demodulated by a demodulator (DEMOD) 1140, and processed by a RX data processor 1142 to extract the reverse link message transmitted by the device 1150. The processor 1130 then determines which pre-coding matrix to use for determining the beam-forming weights then processes the extracted message.

FIG. 11 also illustrates that the communication components may include one or more components that perform physical channel control operations as taught herein. For example, a physical channel control component 1190 may cooperate with the processor 1130 and/or other components of the device 1110 to send signals to another device (e.g., device 1150) via a physical channel as taught herein. Similarly, a physical channel control component 1192 may cooperate with the processor 1170 and/or other components of the device 1150 to receive signals from another device (e.g., device 1110) via a physical channel. It should be appreciated that for each device 1110 and 1150 the functionality of two or more of the described components may be provided by a single component. For example, a single processing component may provide the functionality of the physical channel control component 1190 and the processor 1130 and a single processing component may provide the functionality of the physical channel control component 1192 and the processor 1170.

The teachings herein may be incorporated into various types of communication systems and/or system components. In some aspects, the teachings herein may be employed in a multiple-access system capable of supporting communication with multiple users by sharing the available system resources (e.g., by specifying one or more of bandwidth, transmit power, coding, interleaving, and so on). For example, the teachings herein may be applied to any one or combinations of the following technologies: Code Division Multiple Access (CDMA) systems, Multiple-Carrier CDMA (MCCDMA), Wideband CDMA (W-CDMA), High-Speed Packet Access (HSPA, HSPA+) systems, Time Division Multiple Access (TDMA) systems, Frequency Division Multiple Access (FDMA) systems, Single-Carrier FDMA (SC-FDMA) systems, Orthogonal Frequency Division Multiple Access (OFDMA) systems, or other multiple access techniques. A wireless communication system employing the teachings herein may be designed to implement one or more standards, such as IS-95, cdma2000, IS-856, W-CDMA, TDSCDMA, and other standards. A CDMA network may implement a radio technology such as Universal Terrestrial Radio Access (UTRA), cdma2000, or some other technology. UTRA includes W-CDMA and Low Chip Rate (LCR). The cdma2000 technology covers IS-2000, IS-95 and IS-856 standards. A TDMA network may implement a radio technology such as Global System for Mobile Communications (GSM). An OFDMA network may implement a radio technology such as Evolved UTRA (E-UTRA), IEEE 802.11, IEEE 802.16, IEEE 802.20, Flash-OFDM®, etc. UTRA, E-UTRA, and GSM are part of Universal Mobile Telecommunication System (UMTS). The teachings herein may be implemented in a 3GPP Long Term Evolution (LTE) system, an Ultra-Mobile Broadband (UMB) system, and other types of systems. LTE is a release of UMTS that uses E-UTRA. UTRA, E-UTRA, GSM, UMTS and LTE are described in documents from an organization named “3rd Generation Partnership Project” (3GPP), while cdma2000 is described in documents from an organization named “3rd Generation Partnership Project 2” (3GPP2). Although certain aspects of the disclosure may be described using 3GPP terminology, it is to be understood that the teachings herein may be applied to 3GPP (e.g., Rel99, Re15, Re16, Re17) technology, as well as 3GPP2 (e.g., 1xRTT, 1xEV-DO Rel0, RevA, RevB) technology and other technologies.

The teachings herein may be incorporated into (e.g., implemented within or performed by) a variety of apparatuses (e.g., nodes). In some aspects, a node (e.g., a wireless node) implemented in accordance with the teachings herein may comprise an access point or an access terminal.

For example, an access terminal may comprise, be implemented as, or known as user equipment, a subscriber station, a subscriber unit, a mobile station, a mobile, a mobile node, a remote station, a remote terminal, a user terminal, a user agent, a user device, or some other terminology. In some implementations an access terminal may comprise a cellular telephone, a cordless telephone, a session initiation protocol (SIP) phone, a wireless local loop (WLL) station, a personal digital assistant (PDA), a handheld device having wireless connection capability, or some other suitable processing device connected to a wireless modem. Accordingly, one or more aspects taught herein may be incorporated into a phone (e.g., a cellular phone or smart phone), a computer (e.g., a laptop), a portable communication device, a portable computing device (e.g., a personal data assistant), an entertainment device (e.g., a music device, a video device, or a satellite radio), a global positioning system device, or any other suitable device that is configured to communicate via a wireless medium.

An access point may comprise, be implemented as, or known as a Node B, an eNode B, a radio network controller (RNC), a base station (BS), a radio base station (RBS), a base station controller (BSC), a base transceiver station (BTS), a transceiver function (TF), a radio transceiver, a radio router, a basic service set (BSS), an extended service set (ESS), a macro cell, a macro node, a Home eNB (HeNB), a femto cell, a femto node, a pico node, or some other similar terminology.

In some aspects a node (e.g., an access point) may comprise an access node for a communication system. Such an access node may provide, for example, connectivity for or to a network (e.g., a wide area network such as the Internet or a cellular network) via a wired or wireless communication link to the network. Accordingly, an access node may enable another node (e.g., an access terminal) to access a network or some other functionality. In addition, it should be appreciated that one or both of the nodes may be portable or, in some cases, relatively non-portable.

Also, it should be appreciated that a wireless node may be capable of transmitting and/or receiving information in a non-wireless manner (e.g., via a wired connection). Thus, a receiver and a transmitter as discussed herein may include appropriate communication interface components (e.g., electrical or optical interface components) to communicate via a non-wireless medium.

A wireless node may communicate via one or more wireless communication links that are based on or otherwise support any suitable wireless communication technology. For example, in some aspects a wireless node may associate with a network. In some aspects the network may comprise a local area network or a wide area network. A wireless device may support or otherwise use one or more of a variety of wireless communication technologies, protocols, or standards such as those discussed herein (e.g., CDMA, TDMA, OFDM, OFDMA, WiMAX, Wi-Fi, and so on). Similarly, a wireless node may support or otherwise use one or more of a variety of corresponding modulation or multiplexing schemes. A wireless node may thus include appropriate components (e.g., air interfaces) to establish and communicate via one or more wireless communication links using the above or other wireless communication technologies. For example, a wireless node may comprise a wireless transceiver with associated transmitter and receiver components that may include various components (e.g., signal generators and signal processors) that facilitate communication over a wireless medium.

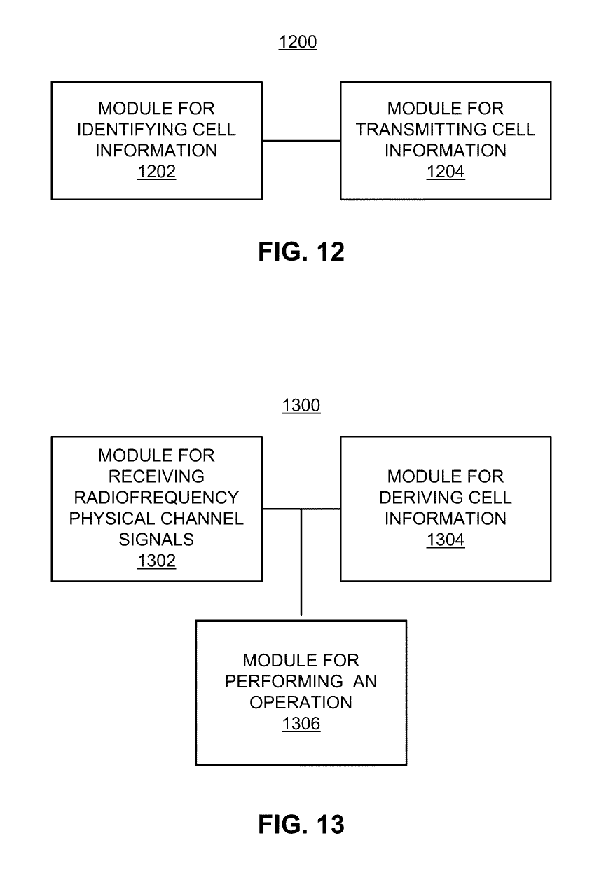

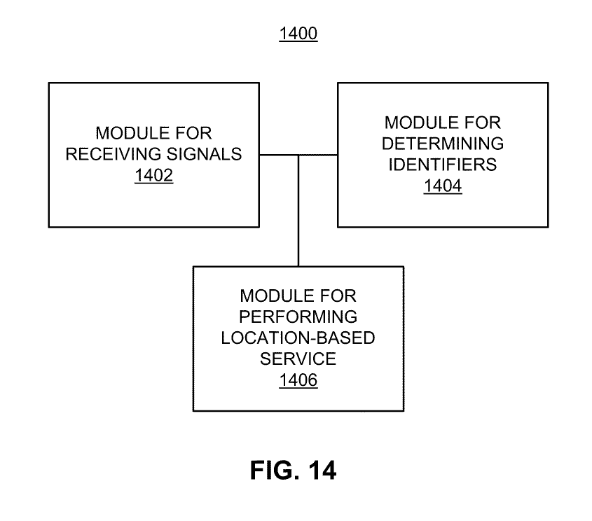

The functionality described herein (e.g., with regard to one or more of the accompanying figures) may correspond in some aspects to similarly designated “means for” functionality in the appended claims. Referring to FIGS. 12-14, apparatuses 1200, 1300, and 1400 are represented as a series of interrelated functional modules. Here, a module for identifying cell information 1202 may correspond at least in some aspects to, for example, a controller as discussed herein. A module for transmitting cell information 1204 may correspond at least in some aspects to, for example, a transmitter as discussed herein. A module for receiving radiofrequency physical channel signals 1302 may correspond at least in some aspects to, for example, a receiver as discussed herein. A module for deriving cell information 1304 may correspond at least in some aspects to, for example, a receiver as discussed herein. A module for performing an operation 1306 may correspond at least in some aspects to, for example, a controller as discussed herein. A module for receiving signals 1402 may correspond at least in some aspects to, for example, a receiver as discussed herein. A module for determining identifiers 1404 may correspond at least in some aspects to, for example, a controller as discussed herein. A module for performing location-based service 1406 may correspond at least in some aspects to, for example, a controller as discussed herein.

The functionality of the modules of FIGS. 12-14 may be implemented in various ways consistent with the teachings herein. In some aspects the functionality of these modules may be implemented as one or more electrical components. In some aspects the functionality of these blocks may be implemented as a processing system including one or more processor components. In some aspects the functionality of these modules may be implemented using, for example, at least a portion of one or more integrated circuits (e.g., an ASIC). As discussed herein, an integrated circuit may include a processor, software, other related components, or some combination thereof. The functionality of these modules also may be implemented in some other manner as taught herein. In some aspects one or more of any dashed blocks in FIGS. 12-14 are optional.

It should be understood that any reference to an element herein using a designation such as “first,” “second,” and so forth does not generally limit the quantity or order of those elements. Rather, these designations may be used herein as a convenient method of distinguishing between two or more elements or instances of an element. Thus, a reference to first and second elements does not mean that only two elements may be employed there or that the first element must precede the second element in some manner. Also, unless stated otherwise a set of elements may comprise one or more elements. In addition, terminology of the form “at least one of: A, B, or C” used in the description or the claims means “A or B or C or any combination of these elements.”

Those of skill in the art would understand that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

Those of skill would further appreciate that any of the various illustrative logical blocks, modules, processors, means, circuits, and algorithm steps described in connection with the aspects disclosed herein may be implemented as electronic hardware (e.g., a digital implementation, an analog implementation, or a combination of the two, which may be designed using source coding or some other technique), various forms of program or design code incorporating instructions (which may be referred to herein, for convenience, as “software” or a “software module”), or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure.

The various illustrative logical blocks, modules, and circuits described in connection with the aspects disclosed herein may be implemented within or performed by an integrated circuit (IC), an access terminal, or an access point. The IC may comprise a general purpose processor, a digital signal processor (DSP), an application specific integrated circuit (ASIC), a field programmable gate array (FPGA) or other programmable logic device, discrete gate or transistor logic, discrete hardware components, electrical components, optical components, mechanical components, or any combination thereof designed to perform the functions described herein, and may execute codes or instructions that reside within the IC, outside of the IC, or both. A general purpose processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

It is understood that any specific order or hierarchy of steps in any disclosed process is an example of a sample approach. Based upon design preferences, it is understood that the specific order or hierarchy of steps in the processes may be rearranged while remaining within the scope of the present disclosure. The accompanying method claims present elements of the various steps in a sample order, and are not meant to be limited to the specific order or hierarchy presented.

In one or more exemplary embodiments, the functions described may be implemented in hardware, software, firmware, or any combination thereof. If implemented in software, the functions may be stored on or transmitted over as one or more instructions or code on a computer-readable medium. Computer-readable media includes both computer storage media and communication media including any medium that facilitates transfer of a computer program from one place to another. A storage media may be any available media that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, includes compact disc (CD), laser disc, optical disc, digital versatile disc (DVD), floppy disk and blu-ray disc where disks usually reproduce data magnetically, while discs reproduce data optically with lasers. Combinations of the above should also be included within the scope of computer-readable media. It should be appreciated that a computer-readable medium may be implemented in any suitable computer-program product.

The previous description of the disclosed aspects is provided to enable any person skilled in the art to make or use the present disclosure. Various modifications to these aspects will be readily apparent to those skilled in the art, and the generic principles defined herein may be applied to other aspects without departing from the scope of the disclosure. Thus, the present disclosure is not intended to be limited to the aspects shown herein but is to be accorded the widest scope consistent with the principles and novel features disclosed herein.

What is claimed is:

1. A method of communication, comprising:
identifying cell information associated with an access point; and
transmitting the cell information by modulating a radiofrequency physical channel based on the cell information.

2. The method of claim 1, wherein the cell information comprises a cell identifier of a cell associated with the access point.

3. The method of claim 1, wherein the cell information comprises a closed subscriber group identifier associated with the access point.

4. The method of claim 1, wherein the modulation of the radiofrequency physical channel based on the cell information comprises modulating a space time transmit diversity (STTD) bit based on the cell information.

5. The method of claim 1, wherein the modulation of the radiofrequency physical channel based on the cell information comprises:
using error correcting coding to generate a codeword based on the cell information; and
using the codeword to modulate the radiofrequency physical channel.

6. The method of claim 5, wherein the error correcting coding encodes the codeword in a manner that provides a defined space time transmit diversity (STTD) value upon demodulation of the modulated radiofrequency physical channel.

7. The method of claim 6, wherein the error correcting coding comprises generating the codeword with a specified weight to provide the defined space time transmit diversity (STTD) value upon demodulation of the modulated radiofrequency physical channel.

8. The method of claim 5, wherein the modulation of the radiofrequency physical channel based on the cell information further comprises providing frame boundary disambiguation information for the codeword if more than one frame is used to transmit the codeword.

9. The method of claim 5, wherein the modulation of the radiofrequency physical channel based on the cell information further comprises providing a frame delimiter for the codeword if more than one frame is used to transmit the codeword.

10. The method of claim 5, wherein the modulation of the radiofrequency physical channel based on the cell information further comprises providing a cyclic redundancy check checksum for the codeword if more than one frame is used to transmit the codeword.

11. The method of claim 1, wherein the radiofrequency physical channel comprises a synchronization channel that includes synchronization information that enables access terminals to synchronize to transmissions by the access point.

12. The method of claim 11, wherein the synchronization channel comprises a Universal Mobile Telecommunications System (UMTS) primary synchronization channel.

13. The method of claim 11, wherein the synchronization channel comprises a Universal Mobile Telecommunications System (UMTS) secondary synchronization channel.

14. The method of claim 1, wherein the radiofrequency physical channel comprises a dedicated physical channel for transmitting the cell information.

15. The method of claim 14, wherein the dedicated physical channel comprises an indication that the dedicated physical channel includes the cell information.

16. The method of claim 1, wherein the modulated radiofrequency physical channel is part of a beacon signal transmitted on a frequency other than an operating frequency of the access point.

17. The method of claim 1, wherein the modulated radiofrequency physical channel is transmitted by an entity that is not co-located with the access point.

18. The method of claim 1, wherein the access point comprises a femto cell.

19. An apparatus for communication, comprising:
a controller operable to identify cell information associated with an access point; and
a transmitter operable to transmit the cell information by modulating a radiofrequency physical channel based on the cell information.

20. The apparatus of claim 19, wherein the cell information comprises a cell identifier of a cell associated with the access point.

21. The apparatus of claim 19, wherein the modulation of the radiofrequency physical channel based on the cell information comprises modulating a space time transmit diversity (STTD) bit based on the cell information.

22. The apparatus of claim 19, wherein the modulation of the radiofrequency physical channel based on the cell information further comprises providing frame boundary disambiguation information for a codeword based on the cell information if more than one frame is used to transmit the codeword.

23. The apparatus of claim 19, wherein the radiofrequency physical channel comprises a synchronization channel that includes synchronization information that enables access terminals to synchronize to transmissions by the access point.

24. The apparatus of claim 19, wherein the radiofrequency physical channel comprises a dedicated physical channel for transmitting the cell information.

25. An apparatus for communication, comprising:
means for identifying cell information associated with an access point; and
means for transmitting the cell information by modulating a radiofrequency physical channel based on the cell information.

26. The apparatus of claim 25, wherein the cell information comprises a cell identifier of a cell associated with the access point.

27. The apparatus of claim 25, wherein the modulation of the radiofrequency physical channel based on the cell information comprises modulating a space time transmit diversity (STTD) bit based on the cell information.

28. The apparatus of claim 25, wherein the modulation of the radiofrequency physical channel based on the cell information further comprises providing frame boundary disambiguation information for a codeword based on the cell information if more than one frame is used to transmit the codeword.

29. The apparatus of claim 25, wherein the radiofrequency physical channel comprises a synchronization channel that includes synchronization information that enables access terminals to synchronize to transmissions by the access point.

30. The apparatus of claim 25, wherein the radiofrequency physical channel comprises a dedicated physical channel for transmitting the cell information.

31. A computer-program product, comprising:
computer-readable medium comprising code for causing a computer to:
identify cell information associated with an access point; and
transmit the cell information by modulating a radiofrequency physical channel based on the cell information.

32. The computer-program product of claim 31, wherein the cell information comprises a cell identifier of a cell associated with the access point.

33. The computer-program product of claim 31, wherein the modulation of the radiofrequency physical channel based on the cell information comprises modulating a space time transmit diversity (STTD) bit based on the cell information.

34. The computer-program product of claim 31, wherein the modulation of the radiofrequency physical channel based on the cell information further comprises providing frame boundary disambiguation information for a codeword based on the cell information if more than one frame is used to transmit the codeword.

35. The computer-program product of claim 31, wherein the radiofrequency physical channel comprises a synchronization channel that includes synchronization information that enables access terminals to synchronize to transmissions by the access point.

36. The computer-program product of claim 31, wherein the radiofrequency physical channel comprises a dedicated physical channel for transmitting the cell information.

37. A method of communication, comprising:
receiving radiofrequency physical channel signals that are modulated based on cell information associated with an access point;
deriving the cell information by demodulating the radiofrequency physical channel signals; and
performing an operation based on the derived cell information.

38. The method of claim 37, wherein the cell information comprises a cell identifier of a cell associated with the access point.

39. The method of claim 37, wherein the cell information comprises a closed subscriber group identifier associated with the access point.

40. The method of claim 37, wherein the demodulation of the radiofrequency physical channel signals comprises identifying a defined space time transmit diversity (STTD) value that is modulated in the radiofrequency physical channel signals.

41. The method of claim 37, wherein the derivation of the cell information comprises:
identifying a codeword as a result of the demodulation of the radiofrequency physical channel signals; and
using error correcting decoding on the codeword based to derive the cell information.

42. The method of claim 41, wherein the derivation of the cell information comprises processing frame boundary disambiguation information included in the radiofrequency physical channel signals to identify a frame boundary for the codeword.

43. The method of claim 41, wherein the derivation of the cell information comprises identifying a frame delimiter included in the radiofrequency physical channel signals to identify a frame boundary for the codeword.

44. The method of claim 41, wherein the derivation of the cell information comprises identifying a cyclic redundancy check checksum included in the radiofrequency physical channel signals to identify a frame boundary for the codeword.

45. The method of claim 37, wherein the radiofrequency physical channel comprises a synchronization channel that includes synchronization information that enables access terminals to synchronize to transmissions by the access point.

46. The method of claim 45, wherein the synchronization channel comprises a Universal Mobile Telecommunications System (UMTS) primary synchronization channel.

47. The method of claim 45, wherein the synchronization channel comprises a Universal Mobile Telecommunications System (UMTS) secondary synchronization channel.

48. The method of claim 37, wherein the radiofrequency physical channel comprises a dedicated physical channel for transmitting the cell information.

49. The method of claim 48, wherein the dedicated physical channel comprises an indication that the dedicated physical channel includes the cell information.

50. The method of claim 37, wherein the access point comprises a femto cell.

51. The method of claim 37, wherein the cell information is derived by an access terminal.

52. The method of claim 51, wherein the operation comprises causing the access terminal to be handed-over to a cell identified by the cell information as a result of deriving the cell information.

53. The method of claim 51, wherein the operation comprises causing the access terminal to reselect to a cell identified by the cell information as a result of deriving the cell information.

54. An apparatus for communication, comprising:
a receiver operable to receive radiofrequency physical channel signals that are modulated based on cell information associated with an access point; and
a controller operable to derive the cell information by demodulating the radiofrequency physical channel signals, and further operable to perform an operation based on the derived cell information.

55. The apparatus of claim 54, wherein the cell information comprises a cell identifier of a cell associated with the access point.

56. The apparatus of claim 54, wherein the demodulation of the radiofrequency physical channel signals comprises identifying a defined space time transmit diversity (STTD) value that is modulated in the radiofrequency physical channel signals.

57. The apparatus of claim 54, wherein the derivation of the cell information comprises processing frame boundary disambiguation information included in the radiofrequency physical channel signals to identify a frame boundary for a codeword that results from the demodulation.

58. The apparatus of claim 54, wherein the radiofrequency physical channel comprises a synchronization channel that includes synchronization information that enables access terminals to synchronize to transmissions by the access point.

59. The apparatus of claim 54, wherein the radiofrequency physical channel comprises a dedicated physical channel for transmitting the cell information.

60. An apparatus for communication, comprising:
means for receiving radiofrequency physical channel signals that are modulated based on cell information associated with an access point;
means for deriving the cell information by demodulating the radiofrequency physical channel signals; and
means for performing an operation based on the derived cell information.

61. The apparatus of claim 60, wherein the cell information comprises a cell identifier of a cell associated with the access point.

62. The apparatus of claim 60, wherein the demodulation of the radiofrequency physical channel signals comprises identifying a defined space time transmit diversity (STTD) value that is modulated in the radiofrequency physical channel signals.

63. The apparatus of claim 60, wherein the derivation of the cell information comprises processing frame boundary disambiguation information included in the radiofrequency physical channel signals to identify a frame boundary for a codeword that results from the demodulation.

64. The apparatus of claim 60, wherein the radiofrequency physical channel comprises a synchronization channel that includes synchronization information that enables access terminals to synchronize to transmissions by the access point.

65. The apparatus of claim 60, wherein the radiofrequency physical channel comprises a dedicated physical channel for transmitting the cell information.

66. A computer-program product, comprising:
computer-readable medium comprising code for causing a computer to:
receive radiofrequency physical channel signals that are modulated based on cell information associated with an access point;
derive the cell information by demodulating the radiofrequency physical channel signals; and
perform an operation based on the derived cell information.

67. The computer-program product of claim 66, wherein the cell information comprises a cell identifier of a cell associated with the access point.

68. The computer-program product of claim 66, wherein the demodulation of the radiofrequency physical channel signals comprises identifying a defined space time transmit diversity (STTD) value that is modulated in the radiofrequency physical channel signals.

69. The computer-program product of claim 66, wherein the derivation of the cell information comprises processing frame boundary disambiguation information included in the radiofrequency physical channel signals to identify a frame boundary for a codeword that results from the demodulation.

70. The computer-program product of claim 66, wherein the radiofrequency physical channel comprises a synchronization channel that includes synchronization information that enables access terminals to synchronize to transmissions by the access point.

71. The computer-program product of claim 66, wherein the radiofrequency physical channel comprises a dedicated physical channel for transmitting the cell information.
